(19) United States
(12) Patent Application Publication
(10) Pub. No.: US 2010/0026914 A1
(43) Pub. Date: Feb. 4, 2010

(54) DIGITAL PHOTO FRAME CAPABLE OF AUTOMATICALLY CHANGING DISPLAY MODE

(75) Inventors: SHIN-HONG CHUNG, Tu-Cheng (TW); XIAO-GUANG LI, Shenzhen City (CN); HAN-CHE WANG, Tu-Cheng (TW); FENG ZHU, Shenzhen City (CN); KUAN-HONG HSIEH, Tu-Cheng (TW); FEN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/475,578

(22) Filed: May 31, 2009

(30) Foreign Application Priority Data
Aug. 1, 2008 (CN) 200820301682.X

(51) Int. Cl. H04N 5/64

(52) U.S. Cl. 348/836; 348/E05.128

(57) ABSTRACT

A digital photo frame (DPF) capable of automatically changing display mode is provided. The DPF includes a display unit, a motion detector, a processing unit, and a storage unit. The motion detector is configured to detect whether there is someone around the DPF, and produce a display switching signal if someone is around the DPF. The processing unit detects current display mode when it receives the display switching signal and change the display mode of the DPF to a slide show mode if current display mode is a still mode. The motion detector also produce a stop signal when it detects nobody around the DPF, the processing unit controls the display unit to display the pictures in the still mode when it receives the stop signal and detects current display mode is the slide show mode.

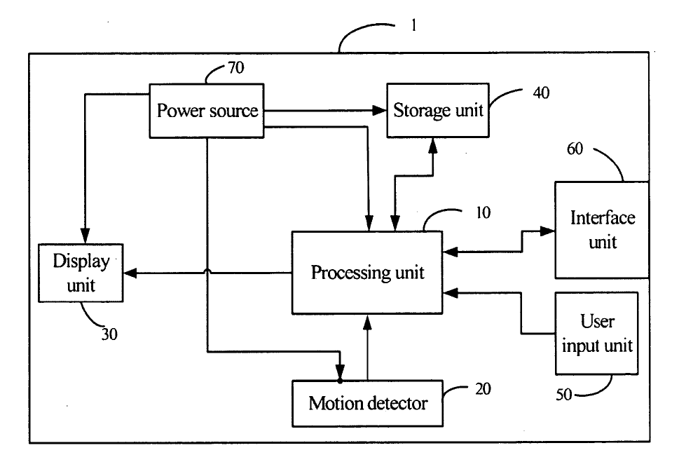

### RELATED APPLICATIONS

This application is related to copending applications entitled, “INTELLIGENT DIGITAL PHOTO FRAME”, filed ______ (Atty. Docket No. US21364); “DIGITAL PHOTO FRAME WITH BATTERY INDICATOR” filed ______ (Atty. Docket No. US21365); “DIGITAL PHOTO FRAME CAPABLE OF ATTRACTING ATTENTION”, filed ______ (Atty. Docket No. US 21366); and “DIGITAL PHOTO FRAME CAPABLE OF ATTRACTING ATTENTION”, filed ______ (Atty. Docket No. US22333).

### BACKGROUND

1. Technical Field

The disclosure relates to electronic devices and, particularly, to a digital photo frame.

2. Description of Related Art

Typically, digital photo frames (DPFs) can be either placed on a table or mounted on a wall. Usually, the DPFs are capable of displaying pictures in a slide show mode or in a still mode. In the slide show mode, people around the DPF can enjoy a large number of pictures displayed by the DPF. However, if there is nobody around and the DPF continues to display pictures in the slide show mode, it would be a waste of electricity. In the still mode, if there is someone around the DPF, they only can view one picture displayed on the DPF unless they manually switch the DPF to slide show mode.

Therefore, it is necessary to provide an electronic device and a method to overcome the above-identified deficiencies.

### BRIEF DESCRIPTION OF THE DRAWINGS

The components in the drawing are not necessarily drawn to scale, the emphasis instead being placed upon clearly illustrating the principles of the electronic device.

The drawing is a block diagram of a digital photo frame in accordance with an exemplary embodiment.

### DETAILED DESCRIPTION

Referring to the drawing, a digital photo frame (DPF) 1 includes a processing unit 10, a motion detector 20, a display unit 30, a storage unit 40, a user input unit 50, an interface unit 60 (e.g., an input port or wireless transceiver), and a power source 70.

The interface unit 60 is configured to connect to an external electronic device (not shown). The external device can be a storage card (e.g., a secure digital card, a compact flash card) or another electronic device (e.g., a digital camera, a mobile phone, or a computer).

The user input unit 50 is configured to generate instructions in response to user operations. The user input unit 50 can be input keys/buttons, knobs, and the like. The power source 70 is configured to provide power to elements of the DPF 1, such as the processing unit 10, the motion detector 20, and the display unit 30.

The storage unit 40 is configured to store displayable media such as digital pictures. The display unit 30 is configured to display the media. In the embodiment, digital pictures (hereinafter pictures) are used as an example to illustrate the present device and method.

The motion detector 20, connected to the processing unit 10, is configured for detecting whether there is someone around the DPF 1 within a predetermined area and producing a display switching signal to the processing unit 10 when there is. The processing unit 10 is configured to receive signals produced by the motion detector 20 and detect a current display mode when receiving the display switching signal. The processing unit 10 is also configured to control the display unit 30 to display the pictures in a slide show mode when it receives the display switching signal and detects the current display mode is a still or static mode, in which a single picture is displayed.

In the embodiment, the motion detector 20 continuously detects whether there is someone around the DPF 1. The motion detector 20 is also configured to produce a stop signal when it detects that nobody is within the predetermined area. The processing unit 10 also detects the current display mode when receiving the stop signal, and controls the DPF 1 to enter the still mode when it detects the current display mode is the slide show mode. When the processing unit 10 controlling the DPF entering the still mode after receiving the stop signal, the processing unit 10 keeps whatever picture being displayed at the moment of receiving the stop signal on display.

The motion detector 20 may include any one or more of the following, an infrared detector, a sonar detector, an audio detector, or the like, which can work singly or in combination according to preset parameters to generate a signal when it is likely one or more persons are present in the predetermined area.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) capable of automatically changing a display mode comprising:
a storage unit storing media, wherein the media comprises digital pictures;
a display unit configured for displaying the pictures in a slide show mode or in a still mode;
a motion detector configured for detecting whether there is someone around the DPF within a predetermined area and producing a display switching signal if there is; and
a processing unit configured for receiving signals produced by the motion detector, detecting a current display mode when receiving the display switching signal; and controlling the display unit to display the pictures in the slide show mode when the current display mode is the still mode.

2. The DPF of claim 1, wherein the motion detector continuously detects whether there is someone around the DPF, if the motion detector detects nobody around the DPF, the motion detector produces a stop signal, and wherein the processing unit is also configured to detect the current display mode when receiving the stop signal, and control the display unit to display the pictures in the still mode when the current display mode is the slide show mode.

3. The DPF of claim 2, wherein the motion detector comprises one selected from the group consisting of an infrared detector, a sonar detector, and an audio detector.

4. The DPF of claim 3, wherein the infrared detector, the sonar detector, and the audio detector can work singly or in combination according to preset parameters to generate a signal when it is likely one or more persons are present in the predetermined area.

5. The DPF of claim 2, wherein when controlling the DPF entering the still mode after receiving the stop signal, the processing unit keeps whatever picture being displayed at the moment of receiving the stop signal on display.

6. A method of automatically change display mode of a digital photo frame (DPF), the DPF comprising:
a storage unit;
a display unit;
a motion detector; and
a processing unit,
the method comprising:
detecting whether there is someone around the DPF via the motion detector;
producing a display change signal when the motion detector detects there is someone around the DPF;
receiving the display switching signal via the processing unit;
detecting current display mode when the processing unit receives the display switching signal; and
switching the display mode to slide show mode under the controlling of the processing unit when it detects current display mode is a still mode.

7. The method of claim 6, further comprising:
producing a stop signal via the motion detector when it detects there is nobody around the DPF;
detecting current display mode when the processing unit receives the stop signal;
switching the display mode to still mode under the controlling of the processing unit when it detects current display mode is the slide show mode.
